(19) United States
(12) Patent Application Publication
(10) Pub. No.: US 2006/0282449 A1
(43) Pub. Date: Dec. 14, 2006

(54) Accessing a common data structure via a customized rule

(75) Inventors: Cale T. Rath, Byron, MN (US); George James Romano, Rochester, MN (US); Tammy Lynn Van Hove, Elgin, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 11/149,480

(22) Filed: Jun. 9, 2005

(51) Int. Cl. G06F 7/00

(52) U.S. Cl. 707/101

(57) ABSTRACT

A method, apparatus, system, and signal-bearing medium that, in an embodiment, access a common data structure via a customized rule. The common data structure is accessed by multiple tools and each tool has a customized rule for accessing the common data structure. Each of the customized rules specifies a subset of the fields in the common data structure, values for which the subset of fields are to be restricted, and a hierarchy of a logically-partitioned computer, where each of the values belongs in the hierarchy. The common data structure has a record for each of the partitions in the logically-partitioned computer, and each of the records contains the fields. In various embodiments, the fields may include an identifier of the associated partition, a recommended operating system for the associated partition, supported operating systems for the associated partition, hardware requirements for the associated partition, software packages that execute in the associated partition, feature codes that represent orderable components for the associated partition, and relationships between the partitions.

### FIELD

An embodiment of the invention generally relates to computers. In particular, an embodiment of the invention generally relates to accessing a common data structure via a customized rule.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated and complex computer software has evolved to take advantage of the higher performance of the hardware, resulting in computer systems today that are much more powerful than just a few years ago.

Because of the power and complexity of computer systems, purchasing or upgrading a computer system is a difficult task. A customer must determine the proper computer system, software, and features to purchase (including the size, speed, or capacity of various devices), order the computer system and its features, and configure and install the computer system. Users often experience great difficulty in determining whether they are purchasing the correct computer system that will have enough capacity and power to run their applications and store their data, now and in the future.

In an attempt to assist users, a variety of current tools exist that aid in determining the appropriate size of a computer system, defining the features to be ordered, ordering the system, and configuring and installing the system after it has been received. But, these disparate tools do not use data generated by the others. For example, a first tool may be used for estimating the capacity of a system and for preplanning the layout and configuration. A second tool orders the computer system and its features and devices. A third tool configures the computer system and installs its features after the customer receives the computer system. But, since the third tool does not share data with the first tool, the configuration and installation of the computer system is not automatically guaranteed to match the configuration that the customer intended when the features were defined and sized during the planning stage. Further, since the second tool does not share data with the first tool, the system ordered is not automatically guaranteed to match the configuration that the customer intended when the features were defined and sized during the planning stage.

These current tools also do not adequately account for pre-requisites and co-requisites of features. For example, certain software packages that a customer would like to use may need a computer with processor and memory of a certain speed and size in order to provide adequate performance. Hence, instead of accounting for all pre-requisites and co-requisites during the planning stage, the system administrator typically learns of hardware that software packages require (e.g., processor speed, memory, or disk space) by reading documentation at the time of installation or by diagnosing performance problems or other errors after installation.

These shortcomings of current planning, ordering, and configuring tools are exacerbated when the computer system uses logical partitions. In a logically-partitioned computer system, a single physical computer operates essentially like multiple and independent virtual computers, referred to as logical partitions, with the various resources in the physical computer (e.g., processors, memory, and input/output devices) allocated among the various logical partitions. Each logical partition executes a separate operating system, and from the perspective of users and of the software applications executing on the logical partition, operates as a fully independent computer. The separate logical partitions typically operate under the control of a partition manager or hypervisor. Planning, ordering, configuring, and installing a logically-partitioned computer is even more difficult than a non-partitioned computer because the logically-partitioned computer may have multiple operating systems, each partition may be allocated only a portion of the resources of the computer system, and the partitions must be planned for and configured.

Hence without a better way to handle planning, ordering, and configuring computer systems, customers will continue to experience difficulty in purchasing and upgrading computer systems.

### SUMMARY

A method, apparatus, system, and signal-bearing medium are provided that, in an embodiment, access a common data structure via a customized rule. The common data structure is accessed by multiple tools and each tool has a customized rule for accessing the common data structure. Each of the customized rules specifies a subset of the fields in the common data structure, values for which the subset of fields are to be restricted, and a hierarchy of a logically-partitioned computer, where each of the values belongs in the hierarchy. The common data structure has a record for each of the partitions in the logically-partitioned computer, and each of the records contains the fields. In various embodiments, the fields may include an identifier of the associated partition, a recommended operating system for the associated partition, supported operating systems for the associated partition, hardware requirements for the associated partition, software packages that execute in the associated partition, feature codes that represent orderable components for the associated partition, and relationships between the partitions.

### BRIEF DESCRIPTION OF THE DRAWING

Various embodiments of the present invention are hereinafter described in conjunction with the appended drawings:

FIG. 1 depicts a block diagram of an example system for implementing an embodiment of the invention.

FIG. 2A depicts a block diagram of an example common system data markup language data structure, according to an embodiment of the invention.

FIG. 2B depicts a block diagram of an example pre-provisioning profile data structure, according to an embodiment of the invention.

FIG. 3 depicts a block diagram of an example customized rule data structure, according to an embodiment of the invention.

FIG. 4 depicts a flowchart of example processing for handling the common system markup language data structure, according to an embodiment of the invention.

FIG. 5 depicts a flowchart of further example processing for handling the common system markup language data structure, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

In an embodiment, a common data structure is provided for use by multiple tools, such as a workload estimator tool, a planning tool, a configuration tool, a virtual I/O server, and a hardware management console. The various tools each use a customized rule (which may be different for some or all of the tools) to access the common data structure. The customized rule may include an identification of the fields in the common data structure that the tool is to access, values for which the fields are to be restricted, and a hierarchy to which the values belong. In various embodiments, the tools may use their respective customized rules and the common data structure to determine recommended and supported operating systems for partitions in a logically-partitioned computer, determine if the computer has sufficient hardware capacity to support the software packages that are to execute in the partitions, determine features for the computer, order the features, and configure the partitions in the computer.

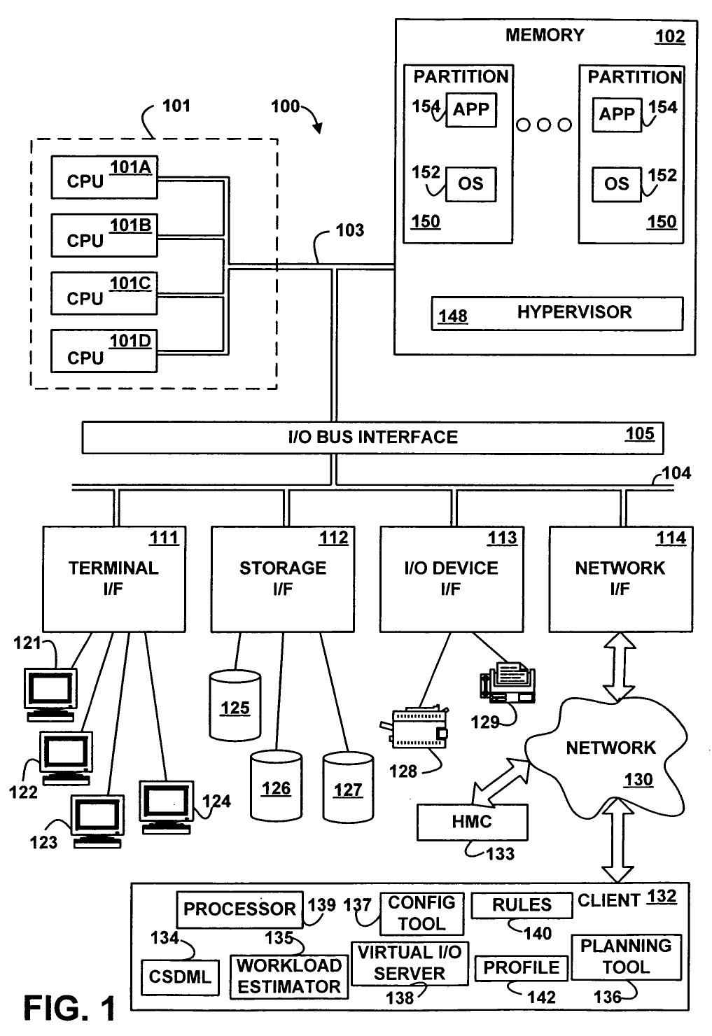

Referring to the Drawings, wherein like numbers denote like parts throughout the several views, FIG. 1 depicts a high-level block diagram representation of a computer system 100 connected via a network 130 to a client 132 and a hardware management console 133, according to an embodiment of the present invention. The terms “computer system” and “client” are used for convenience only, any appropriate electronic devices may be used, and in various embodiments a computer system or electronic device that operates as a client in one context may operate as a server in another context. The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as a processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 is illustrated as containing the primary software components and resources utilized in implementing a logically-partitioned computing environment on the computer 100, including a plurality of logical partitions 150 managed by a partition manager or hypervisor 148. Although the partitions 150 and the hypervisor 148 are illustrated as being contained within the memory 102 in the computer system 100, in other embodiments some or all of them may be on different computer systems or other electronic devices accessed remotely, e.g., via the network 130. Further, the computer system 100 may use virtual addressing mechanisms that allow the programs of the computer system 100 to behave as if they only have access to a large, single storage entity instead of access to multiple, smaller storage entities. Thus, while the hypervisor 148 and the partitions 150 are illustrated as residing in the memory 102 in the computer 100, these elements are not necessarily all completely contained in the same storage device, or in the same computer, at the same time.

Each of the logical partitions 150 utilizes an operating system 152, which controls the primary operations of the logical partition 150 in the same manner as the operating system of a non-partitioned computer. For example, each operating system 152 may be implemented using the i5OS operating system available from International Business Machines Corporation, but in other embodiments the operating system 152 may be Linux, AIX, UNIX, Microsoft Windows, or any appropriate operating system. Also, some or all of the operating systems 152 may be the same or different from each other. Any number of logical partitions 150 may be supported as is well known in the art, and the number of the logical partitions 150 resident at any time in the computer 100 may change dynamically as partitions are added or removed from the computer 100.

Each of the logical partitions 150 executes in a separate, or independent, memory space, and thus each logical partition acts much the same as an independent, non-partitioned computer from the perspective of each application(s) 154 that executes in each such logical partition. As such, user applications, e.g., the applications 154, typically do not require any special configuration for use in a partitioned environment. Given the nature of logical partitions 150 as separate virtual computers, it may be desirable to support inter-partition communication to permit the logical partitions to communicate with one another as if the logical partitions were on separate physical machines. Although the logical partitions 150 are illustrated as operating as virtual computers within the computer 100, in another embodiment, one of the logical partitions 150 may operate as the entire computer, or as a group of computers, such as one or more servers connected via the network 130.

In some embodiments, the partitions 150 may support unillustrated virtual local area network (LAN) adapters to permit the logical partitions 150 to communicate with one another and/or the client 132 and the hardware management console 133 via a networking protocol such as the Ethernet protocol. In another embodiment, the virtual network adapter may bridge to a physical adapter, such as the network interface adapter 114. Other manners of supporting communication between partitions 150, the client 132, and the hardware management console 133 may also be supported consistent with embodiments of the invention.

Although the hypervisor 148 is illustrated as being within the memory 102, in other embodiments, all or a portion of the hypervisor 148 may be implemented in firmware or hardware. The hypervisor 148 may perform both low-level partition management functions, such as page table management and may also perform higher-level partition management functions, such as creating and deleting partitions, concurrent I/O maintenance, allocating processors, memory and other hardware or software resources to the various partitions 150. In another embodiment, the hypervisor 148 is optional, not present, or not used.

The hypervisor 148 statically and/or dynamically allocates to each logical partition 150 a portion of the available resources in computer 100. For example, each logical partition 150 may be allocated one or more of the processors 101 and/or one or more hardware threads, as well as a portion of the available memory space. The logical partitions 150 can share specific software and/or hardware resources such as the processors 101, such that a given resource may be utilized by more than one logical partition. In the alternative, software and hardware resources can be allocated to only one logical partition 150 at a time. Additional resources, e.g., mass storage, backup storage, user input, network connections, and the I/O adapters therefor, are typically allocated to one or more of the logical partitions 150. Resources may be allocated in a number of manners, e.g., on a bus-by-bus basis, or on a resource-by-resource basis, with multiple logical partitions sharing resources on the same bus. Some resources may even be allocated to multiple logical partitions at a time. The resources identified herein are examples only, and any appropriate resource capable of being allocated may be used.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127.

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may, in fact, contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100, the client 132, and/or the hardware management console 133. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

Although the client 132 and the hardware management console 133 are illustrated as being connected to the computer system 100 via the network 130 and the network interface 114, in another embodiment, one or both of them may be connected to the computer system via a virtual network adapter without the benefit of the network interface 114 and/or the network 130. The client 132 includes a common system data markup language data structure 134, a workload estimator 135, a planning tool 136, a configuration tool 137, a virtual I/O server 138, a processor 139, customized rules 140, and a pre-provisioning profile 142. The client 132 and the hardware management console 133 may further include any or all of the hardware and/or software components previously described above for the computer 100. The processor 139 is analogous to that previously described above for the processor 101.

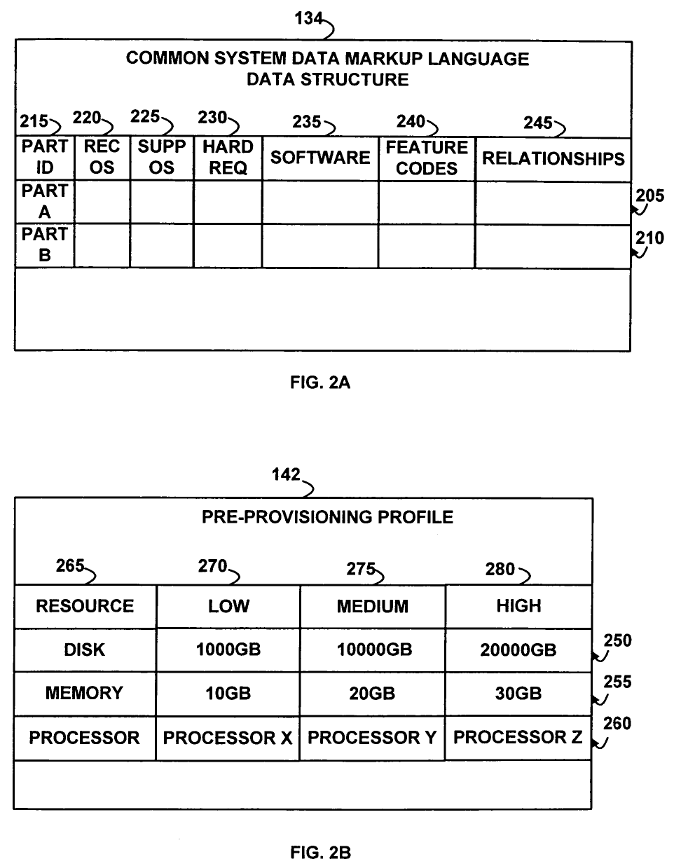

The common system data markup language data structure 134 is a data structure common to a variety of tools (e.g., the hardware management console 133, the workload estimator 135, the planning tool 136, the configuration tool 137, and the virtual I/O server 138) that is used to store data that relates to the planning, ordering, and configuring of features and partitions 150 in the logically-partitioned computer system 100. The common system data markup language data structure 134 is further described below with reference to FIG. 2A.

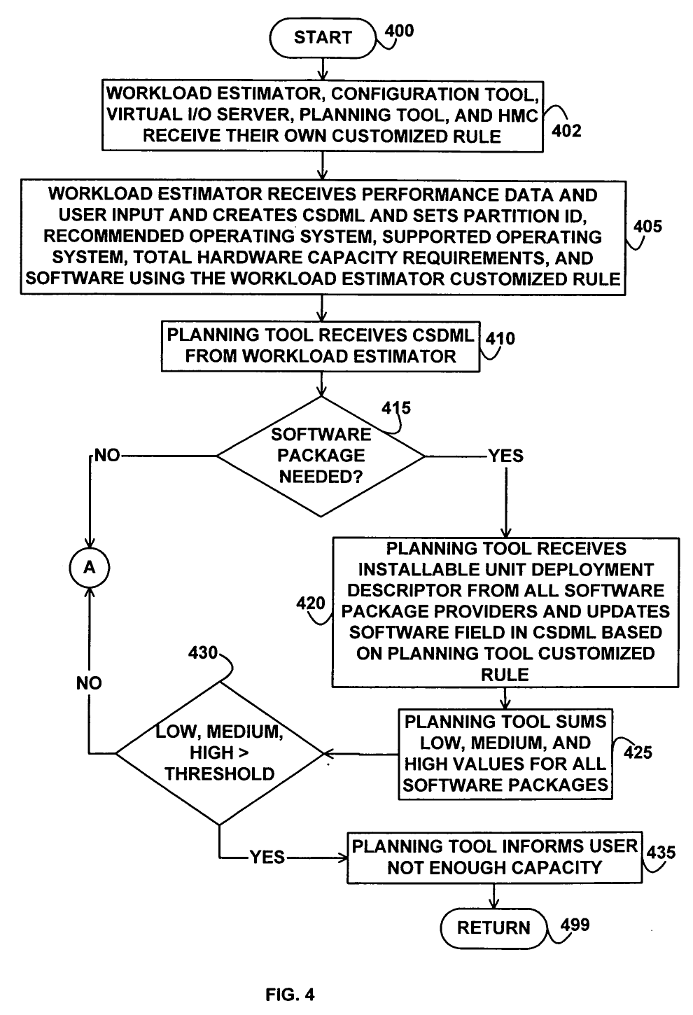

The workload estimator 135 analyzes solution definitions (e.g., the applications 154) and capacity statistics to generate information in the common system data markup language data structure 134 that describes the recommended systems and partitioned configurations 150 needed to support the solution. The workload estimator 135 also identifies the recommended and supported operating systems (e.g. the operating systems 152) onto which the solution elements will be deployed. The workload estimator 135 also identifies the total hardware requirements (physical and/or virtual) needed to support the runtime of the solution plus the operating systems needs. The workload estimator 135 uses the customized rule 140 in order to store, retrieve, and interpret the data in the common system data markup language data structure 134. The functions of the workload estimator 135 are further described below with reference to FIG. 4.

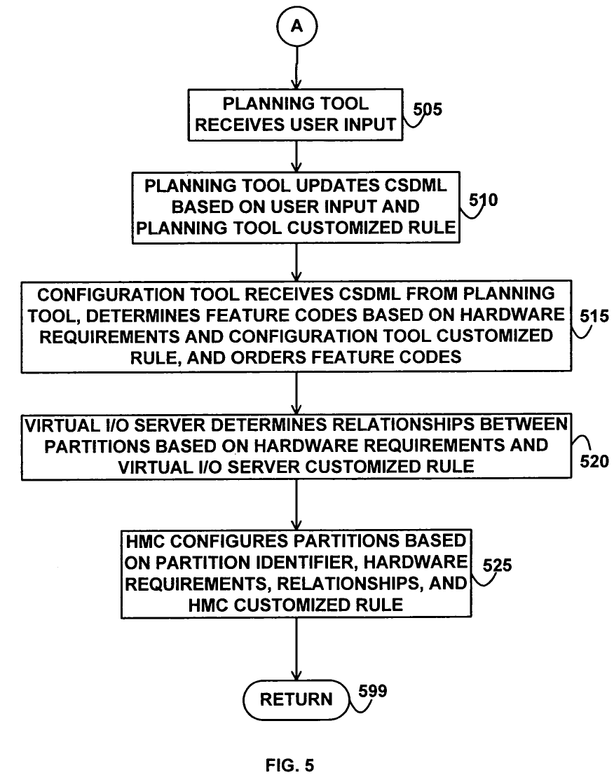

The planning tool 136 determines whether a software package is needed based on the common system data markup language data structure 134, receives a descriptor for the software package if needed from the supplier of the software package, and updates the common system data markup language data structure 134 based on the descriptor for the software package and user input. The planning tool 136 uses the customized rule 140 in order to store, retrieve, and interpret the data in the common system data markup language data structure 134. The functions of the planning tool 136 are further described below with reference to FIGS. 4 and 5.

The configuration tool 137 determines the feature codes to order based on the common system data markup language data structure 134 and places the order. The configuration tool 137 uses the customized rule 140 in order to store, retrieve, and interpret the data in the common system data markup language data structure 134. The functions of the configuration tool 137 are further described below with reference to FIG. 5.

The virtual I/O server 138 manages the relationships between the partitions 150 via the common system data markup language data structure 134. The virtual I/O server 138 uses the customized rule 140 in order to store, retrieve, and interpret the data in the common system data markup language data structure 134.

The hardware management console 133 configures the partitions 150 based on the common system data markup language data structure 134. The hardware management console 133 uses the customized rule 140 in order to store, retrieve, and interpret the data in the common system data markup language data structure 134. The functions of the hardware management console 133 are further described below with reference to FIG. 5.

In an embodiment, the hardware management console 133, the workload estimator 135, the planning tool 136, the configuration tool 137, and/or the virtual I/O server 138 include instructions stored in memory (analogous to the description for the memory 102) capable of executing on a processor or statements capable of being interpreted by instructions executing on a processor to perform the functions as further described below with reference to FIGS. 4 and 5. In another embodiment, the hardware management console 133, the workload estimator 135, the planning tool 136, the configuration tool 137, and/or the virtual I/O server 138 may be implemented in microcode or firmware. In another embodiment, the hardware management console 133, the workload estimator 135, the planning tool 136, the configuration tool 137, and/or the virtual I/O server 138 may be implemented in hardware via logic gates and/or other appropriate hardware techniques. Although the client 132 and the hardware management console 133 are illustrated as being separate, in another embodiment they, or a portion thereof, may be packaged together.

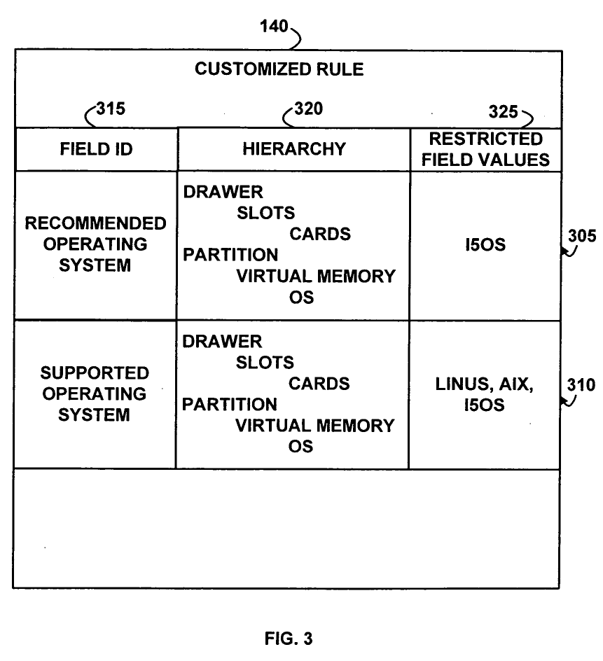

In an embodiment, different data is stored in the customized rules 140 for each of the tools (e.g., the hardware management console 133, the workload estimator 135, the planning tool 136, the configuration tool 137, the virtual I/O server 138, or for any other tool) that needs to access the common system data markup language data structure 134. The rules 140, as customized for one such tool, are further described below with reference to FIG. 3.

It should be understood that FIG. 1 is intended to depict the representative major components of the computer system 100, the client 132, and the hardware management console 133 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, the client 132, and/or the hardware management console 133, and that, when read and executed by one or more processors, e.g., the processor 101 and the processors 139) in the computer system 100, the client 132, or the hardware management console 133, cause the computer system 100, the client 132, and the hardware management console 133 to perform the steps or elements comprising the various aspects of embodiments of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100, the client 132, and/or the hardware management console 133 via a variety of tangible signal-bearing media, which include, but are not limited to:

(1) information permanently stored on a non-rewriteable storage medium, e.g., a read-only memory device attached to or within a computer system, such as a CD-ROM, DVD-R, or DVD+R;

(2) alterable information stored on a rewriteable storage medium, e.g., a hard disk drive (e.g., the DASD 125, 126, or 127), CD-RW, DVD-RW, DVD+RW, DVD-RAM, or diskette; or

(3) information conveyed by a transmissions or communications medium, such as through a computer or a telephone network, e.g., the network 130.

Such tangible signal-bearing media, when carrying or encoding processor-readable, computer-readable, or machine-readable instructions or statements that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2A depicts a block diagram of an example common system data markup language data structure 134, according to an embodiment of the invention. The example common system data markup language data structure 134 includes records 205 and 210, but in other embodiments any number of records with any appropriate data may be present. Each of the records 205 and 210 includes a partition identifier field 215, a recommended operating system field 220, a supported operating system field 225, a hardware requirements field 230, a software package field 235, a feature codes field 240, and a relationships field 245. Thus, each of the records 205 and 210 is separated into and contains the fields 215, 220, 225, 230, 235, 240, and 245.

The partition identifier field 215 identifies the partition 150 associated with the record. The recommended operating system field 220 identifies the operating system 152 that is recommended to be used with the identified partition 215. The supported operating system feel 225 identifies the operating system(s) 152 that the associated partition 215 supports, regardless of whether that operating system is recommended. The hardware requirements field 230 identifies the hardware (e.g., the amount of disk, memory, and processor, or any other resource) that is required for the supported operating system 225 and the software 235 to run in the partition 150 identified by the partition 215. The software field 235 identifies a software package that executes in the partition 215. The feature code 240 identifies hardware and/or software components of the computer system 100 that may be ordered to support the associated partition 215, supported operating system 225, hardware requirements 230, and/or software 235. The relationships field 245 indicates relationships between the partition 215 associated with the record and other of the partitions 215.

FIG. 2B depicts a block diagram of an example pre-provisioning profile 142, according to an embodiment of the invention. The example pre-provisioning profile 142 includes records 250, 255, and 260, but in other embodiments any number of records with any appropriate data may be present. Each of the records 250, 255, and 260 includes a resource field 265, a low field 270, a medium field 275, and a high field 280. The resource field 265 indicates a resource of the computer system 100 that may be needed to support the software 235, the recommended operating system 220, and/or the supported operating system 225 in the partition 215. The low field 270 indicates a low or minimum amount or level of the associated resource 265 that may be needed to support the software 235, the recommended operating system 220, and/or the supported operating system 225. The medium field 275 indicates a medium amount or level of the associated resource 265 that may be needed to support the software 235, the recommended operating system 220, and/or the supported operating system 225. The high field 280 indicates a high amount or level of the associated resource 265 that may be needed to support the software 235, the recommended operating system 220, and/or the supported operating system 235 in the partition 215.

FIG. 3 depicts a block diagram of an example rule 140 customized for one of the tools 133, 135, 136, 137, and 138, according to an embodiment of the invention. Each of the tools 133, 135, 136, 137, and 138 may have a different customized rule 140. The example customized rule 140 includes records 305 and 310, but in other embodiments any number of records with any appropriate data may be present. In an embodiment, the customized rule 140 includes a record associated with each of the fields in the common system data markup language data structure 134 that the associated tool accesses.

Each of the records 305 and 310 includes a field identifier 315, a hierarchy field 320, and a restricted field values field 325. The field identifier 315 indicates the field in the common system data markup language data structure 134 that corresponds to the associated record in the customized rule 140. Each of the customized rules for each of the tools 133, 135, 136, 137, and 138 may have the same or different fields 315 depending on the fields in the common system data markup language data structure 134 that the corresponding tool accesses. Thus, the fields 315 in the records 305 and 310 in the customized rule 140 for one particular tool may specify a subset (any, some, or all) of the fields 215, 220, 225, 230, 235, 240, and 245 of the common system data markup language data structure 134.

The hierarchy field 320 indicates the hierarchy of the values 325 of the field 315 in the computer system 100. For example, as indicated in the record 305, the recommended operating system as indicated in the value 325 is contained in the virtual memory of a partition within the computer system 100. The restricted field values 325 indicates the values that the field in the common system data markup language data structure 134 identified by the field 315 in the customized rule 140 is restricted to when used by the corresponding tool for which the rule 140 is customized. For example, as indicated by the record 305, the recommended operating system field 220 is restricted to the operating system “I5OS” when used by the corresponding tool.

FIG. 4 and FIG. 5 depict flowcharts of example processing for handling the common system markup language data structure 134 via the customized rules 140 by the tools, according to an embodiment of the invention. The logic of FIGS. 4 and 5 may be performed for each partition 150 in the computer system 100.

Control begins at block 400. Control then continues to block 402 where the workload estimator 135, the planning tool 136, the configuration tool 137, the virtual I/O server 138, and the hardware management console 133 receive their respective customized rule 140.

Control then continues to block 405 where the workload estimator 135 receives performance data and user input. The workload estimator 135 further creates the common system data markup language data structure 134 and sets the partition identifier 215, the recommended operating system 220, the supported operating system 225, the total hardware capacity requirements 230, and the software 235 in the common system data markup language data structure 134 based on the performance data, the user input, and the customized rule 140. In various embodiments, the workload estimator 135 determines the recommended operating system 220 based on the performance data, based on user input, based on a predetermined operating system, or based on the recommended operating system specified in the restricted field values 325 of the customized rule 140. In an embodiment, the workload estimator 135 determines the software 235 based on software packages selected via user input. The workload estimator 135 uses the customized rule 140 to determine the fields to access in the common system data markup language data structure 134 and to determine the values to store in the fields.

Control then continues to block 410 where the planning tool 136 receives the common system data markup language data structure 134 from the workload estimator 135. Control then continues to block 415 where the planning tool 136 determines whether a software package (e.g., the application 154) is needed for the computer system 100 based on whether any software package is specified in the software field 235 in the common system data markup language data structure 134 and based on the rule 140 customized for the planning tool 136.

If the determination at block 415 is true, then one or more software packages are needed, so control continues to block 420 where the planning tool 136 receives an installable unit deployment descriptor from all the providers (e.g., the manufacturer, distributor, licensor, or seller) of the needed software packages. The installable unit deployment descriptor identifies the hardware capacity requirements that are needed by the computer system 100 to support the software described by the installable unit deployment descriptor. The planning tool 136 further updates the pre-provisioning profile 142 to reflect the data from the installable unit deployment descriptors using the customized rule 140. Control then continues to block 425 where the planning tool 136 adds the values in the low fields 274, the medium fields 275, and the high fields 280 in the pre-provisioning profile 142 for all respective software packages to produce a total sum of low, medium, and high resource requirements representing the aggregate of all the software packages.

Control then continues to block 430 where the planning tool 136 determines whether any or all of the summed low fields 274, medium fields 275 and/or high fields 280 are greater than a threshold or thresholds specified by the hardware requirements field 230 in the common system data markup language data structure 134. If the determination at block 430 is true, then control continues to block 435 where the planning tool 136 informs the user that the computer system 100 that the user desires to order does not have enough capacity to support the desired software packages. Control then continues to block 499 where the logic of FIG. 4 returns.

If the determination at block 430 is false, then control continues to block 505 (FIG. 5) where the planning tool 136 receives input from the customer, such as a system administrator or other user. For example, the customer may select the recommended operating system 220 or one of the supported operating systems 225 for ordering. Control then continues to block 510 where the planning tool 136 updates the common system data markup language data structure 134 based on the user input to indicate the options that the user has selected for ordering based on the customized rule 140.

Control then continues to block 515 where the configuration tool 137 receives the common system data markup language data structure 134 from the planning tool 136. The configuration tool 137 further determines the feature codes that are necessary to support the hardware requirements 230 and sets the feature codes in the feature codes field 240 using the customized rule 140. The configuration tool 137 further orders the computer system 100 or the features of the computer system 100 as specified by the feature codes 240 from the supplier of the computer system 100 using the customized rule 140.

Control then continues to block 520 where the virtual I/O server 138 determines the relationships 245 between the partition 150 identified in the partition identifier 215 and other partitions in the computer system 100 using the customized rule 140. Control then continues to block 525 where the hardware management console 133 receives the common system data markup language data structure 134 from the configuration tool 137 and configures the partitions 150 in the computer system 100, once the ordered computer system or the ordered features have been received, based on the partition identifier 215, the hardware requirements 230, the relationships 245, and the rule 140 customized for the hardware management console 133. Control then continues to block 599 where the logic of FIG. 5 returns.

If the determination at block 415 of FIG. 4 is false, then a software package is not needed, so control continues from block 415 of FIG. 4 to block 505 of FIG. 5, as previously described above.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
receiving a first rule of a plurality of rules for accessing a common data structure, wherein the common data structure is accessed by a plurality of tools and wherein each of the plurality of rules are customized for each of the plurality of respective tools, wherein each of the plurality of rules specifies a subset of fields in the common data structure and values for which the subset of fields are restricted; and
accessing the common data structure via the first rule.

2. The method of claim 1, wherein the rule further comprises a hierarchy of a logically-partitioned computer, wherein each of the values belongs in the hierarchy.

3. The method of claim 1, wherein the common data structure comprises a plurality of records, wherein each of the plurality of records is associated with a respective partition in a logically-partitioned computer, and wherein each of the plurality of records contains the fields.

4. The method of claim 3, wherein the fields comprise:
an identifier of the associated partition; and
a recommended operating system for the associated partition.

5. The method of claim 3, wherein the fields comprise:
supported operating systems for the associated partition.

6. The method of claim 3, wherein the fields comprise:
hardware requirements for the associated partition.

7. The method of claim 3, wherein the fields comprise:
software packages that execute in the associated partition.

8. The method of claim 3, wherein the fields comprise:
feature codes that represent orderable components for the associated partition.

9. The method of claim 3, wherein the fields comprise:
relationships between a plurality of partitions in the logically-partitioned computer.

10. A signal-bearing medium encoded with a common data structure, wherein the common data structure comprises a plurality of records, wherein each of the plurality of records is associated with a respective partition in a logically-partitioned computer, and wherein each of the plurality of records comprises:
a identifier field that identifies the associated respective partition in the logically-partitioned computer;
a recommended operating system field, wherein a workload estimator tool stores a recommended operating system for the associated partition in the recommended operating system field based on a first rule customized for the workload estimator tool; and
a hardware requirements field, wherein a planning tool receives a plurality of levels of hardware requirements for a plurality of software packages from providers of the plurality of software packages, calculates a sum of the levels for the plurality of software packages, and determines whether the sum is greater than a threshold specified in the hardware requirements field based on a second rule customized for the planning tool.

11. The signal-bearing medium of claim 10, further comprising:
a feature codes field, wherein a configuration tool determines feature codes based on the hardware requirements field, stores the feature codes in the feature codes field, and orders features represented by the feature codes based on a third rule customized for the configuration tool.

12. The signal-bearing medium of claim 10, wherein a hardware management console configures the plurality of partitions in the logically-partitioned computer based on the hardware requirements field and based on a fourth rule customized for the hardware management console.

13. The signal-bearing medium of claim 10, further comprising:
a supported operating systems field, wherein the workload estimator tool stores supported operating systems for the associated partition in the supported operating systems field based on the first rule customized for the workload estimator tool.

14. The signal-bearing medium of claim 10, further comprising:
a software packages field, wherein the workload estimator stores identifiers of the software packages in the software packages field based on the first rule.

15. The signal-bearing medium of claim 10, further comprising:
a relationships field, wherein a virtual I/O server determines relationships between the logical partitions and stores the relationships in the relationships field based on a fifth rule customized for the virtual I/O server.

16. A computer system comprising a processor communicatively coupled to the signal bearing medium of claim 10.

17. A method for configuring a client comprising:
configuring the client to receive a first rule of a plurality of rules for accessing a common data structure, wherein the common data structure is accessed by a plurality of tools and wherein each of the plurality of rules are customized for each of the plurality of respective tools, wherein each of the plurality of rules specifies a subset of fields in the common data structure and values for which the subset of fields are restricted; and
configuring the client to access the common data structure via the first rule, wherein the common data structure comprises a plurality of records, wherein each of the plurality of records is associated with a respective partition in a logically-partitioned computer, and wherein each of the plurality of records contains the fields.

18. The method of claim 16, wherein the rule further comprises a hierarchy of the logically-partitioned computer, wherein each of the values belongs in the hierarchy.

19. The method of claim 16, wherein the fields comprise:
an identifier of the associated partition;
a recommended operating system for the associated partition;
supported operating systems for the associated partition;
hardware requirements for the associated partition; and
software packages that execute in the associated partition.

20. The method of claim 16, wherein the fields comprise:
feature codes that represent orderable components for the associated partition; and
relationships between a plurality of partitions in the logically-partitioned computer.
